(19) United States
(12) Patent Application Publication
(10) Pub. No.: US 2018/0043724 A1
(43) Pub. Date: Feb. 15, 2018

(54) DIFFRACTIVE DEVICE PRODUCING ANGLE DEPENDENT EFFECTS

(71) Applicant: CCL SECURE PTY LTD, Craigieburn, Victoria (AU)

(72) Inventors: Michael HARDWICK, Craigieburn, Victoria (AU); Robert LEE, Craigieburn, Victoria (AU)

(73) Assignee: CCL SECURE PTY LTD, Craigieburn, Victoria (AU)

(21) Appl. No.: 15/554,411

(22) PCT Filed: Mar. 3, 2016
(86) PCT No.: PCT/AU2016/050144

§ 371 Date: Aug. 29, 2017

(30) Foreign Application Priority Data
Mar. 6, 2015 (AU) 2015100282
Mar. 6, 2015 (AU) 2015900804

(51) Int. Cl. B42D 25/328; B42D 25/351; G02B 5/18; B42D 25/378

(52) U.S. Cl. CPC B42D 25/328; B42D 25/378; B42D 25/351; G02B 5/1861; G02B 5/1842; G07D 7/128

(57) ABSTRACT

An optical device for authenticating articles of value, the optical device including: a first diffractive structure for generating a first diffractive image; a second diffractive structure for generating a second diffractive image; and a non-diffractive structure; wherein, the first and second diffractive structures, and the non-diffractive structure, are positioned relative to each other such that when viewed from a first angle, both the first and second diffractive images are visible, and when viewed from a second angle, the first diffractive image is visible while the second diffractive image is not visible.

### FIELD OF THE INVENTION

The invention relates to optical devices, particularly, but not exclusively, when applied to security documents or tokens as a counterfeit deterrent. The invention also relates to production methods for manufacturing the optical devices as well as security documents or tokens which incorporate the optical devices

### DEFINITIONS

### Security Document or Token

As used herein the term security documents and tokens includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents or tokens such as banknotes or identification documents such as identity cards or passports formed from a substrate to which one or more layers of printing are applied. The diffraction gratings and optically variable devices described herein may also have application in other products, such as packaging.

### Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

### Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET), biaxially-oriented polypropylene (BOPP); or a composite material of two or more materials, such as a laminate of paper and at least one plastic material, or of two or more polymeric materials.

### Diffractive Optical Elements (DOEs)

As used herein, the term diffractive optical element refers to a numerical-type diffractive optical element (DOE). Numerical-type diffractive optical elements

(DOEs) rely on the mapping of complex data that reconstruct in the far field (or reconstruction plane) a two-dimensional intensity pattern. Thus, when substantially collimated light, e.g. from a point light source or a laser, is incident upon the DOE, an interference pattern is generated that produces a projected image in the reconstruction plane that is visible when a suitable viewing surface is located in the reconstruction plane, or when the DOE is viewed in transmission at the reconstruction plane. The transformation between the two planes can be approximated by a fast Fourier transform (FFT). Thus, complex data including amplitude and phase information has to be physically encoded in the micro-structure of the DOE. This DOE data can be calculated by performing an inverse FFT transformation of the desired reconstruction (i.e. the desired intensity pattern in the far field).

DOEs are sometimes referred to as computer-generated holograms, but they differ from other types of holograms, such as rainbow holograms, Fresnel holograms and volume reflection holograms.

### Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as sub-wavelength gratings, transmissive diffractive gratings and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, e.g. nitro-cellulose.

The radiation curable inks and lacquers used herein have been found to be particularly suitable for embossing microstructures, including diffractive structures such as diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-linked or uncross-linked hydroxylated acrylates; polyurethanes; and UV curing anionic or cationic acrylates. Examples of suitable cross-linkers include: isocyanates; polyaziridines; zirconium complexes; aluminium acetylacetone; melamines; and carbodi-imides.

### Optically Variable Image or Device (OVD)

An optically variable image or device is a security feature or device that changes in appearance. OVDs provide an optically variable effect when the banknote is tilted and/or when the viewing angle of the observer relative to the OVD changes. The image of an OVD may also be changed by aligning a verification device over the security feature or device. An OVD may be provided by a printed area, e.g. an area printed with metallic inks or iridescent inks, by an embossed area, and by a combination of a printed and embossed feature. An OVD may also be provided by a diffractive device, such as a diffraction grating or a hologram and may include arrays of microlenses and lenticular lenses.

### BACKGROUND OF THE INVENTION

A variety of security devices are applied to security documents and tokens to deter counterfeiters. For example banknotes may have a transparent window, metallic foil area, diffractive device or some other type of optically variable device which can not be accurately copied by a colour photocopier or easily replicated by other means. Diffractive optical elements (DOE's), holograms and diffractive gratings are known security devices which generate striking visual effects and the equipment required to accurately replicate them is expensive.

Despite this, more sophisticated counterfeiters do have access to the necessary equipment. Hence, there is an ongoing need to increase the complexity of security devices and make the optical impressions they generate increasingly unusual or unique. This makes the security device evermore difficult to replicate but the visual impression it generates still provides an immediately apparent indication of authenticity.

An optical device having unusual or unique optical impressions is desirable in the security industry but may also have applications in other industries.

### SUMMARY OF THE INVENTION

In light of the above, a first aspect of the present invention provides an optical device for authenticating articles of value, the optical device including:

a first diffractive structure for generating a first diffractive image;

a second diffractive structure for generating a second diffractive image; and

a non-diffractive structure;

wherein,

the first and/or second diffractive structures are formed on the non-diffractive structure such that when viewed from a first angle, both the first and second diffractive images are visible, and when viewed from a second angle, the first diffractive image is visible while the second diffractive structure is obscured by the non-diffractive structure.

Preferably, the optical device is formed on a substrate having a first surface, wherein the first diffractive structure is at a first height relative to the first surface, and the second diffractive structure is at a second height relative to the first surface such that a difference between the first and second heights obscures the second diffractive structure when viewed from the second angle.

Optionally, the non-diffractive structure has a taller profile than the first and second diffractive structures such that when viewed in reflection from the second angle, only the first diffractive image is visible.

Optionally, the non-diffractive structure forms depressions between the first and second diffractive structures, and the substrate is transparent or translucent such that when viewed in transmission from the second angle only the first diffractive structure is visible.

Optionally, the depressions contain opaque material.

Preferably, the first and second diffractive structures each include a plurality of diffractive elements, the diffractive elements of the second diffractive structure being interlaced with the diffractive elements of the first diffractive structure. Optionally, the height difference between the first height and the second height is at least 4 μm.

Optionally, the optical device further includes a third diffractive structure provided at a third height relative to the first surface for producing a third diffractive image, the third diffractive structure including a plurality of diffractive elements interlaced with the diffractive elements of the first and second diffractive structures.

In some embodiments of this option, the third diffractive structure is at substantially the same height as the second diffractive structure, and the diffractive elements of the second and third diffractive structures are on opposing sides of the diffractive elements of the first diffractive structure such that the first and second diffractive images are visible from the first angle, the first and third diffractive images are visible from the second angle, and the first, second and third diffractive images are visible from a third angle.

In another embodiment, the third height is lower than the second height, and wherein the diffractive elements of the second and third diffractive structures are provided on the same side of the diffractive elements of the first diffractive structure such that the first and second diffractive images are visible from the first angle while the third diffractive image is obscured, and only the first diffractive image is visible from the second angle which is more acute than the first angle.

Preferably, the non-diffractive structure provides height differences between adjacent diffractive elements of at least 1 μm. In a further preferred form, the height differences are between 1 μm and 4 μm.

Preferably, the width of the diffractive elements is between 1 μm to 3 μm.

Optionally, at least one of the first, second or third diffractive images is a hologram. In a further option, at least one of the first, second or third diffractive structures is a diffractive grating.

In a second aspect, the present invention provides a security device incorporating an optical device according to the first aspect of the invention described above.

In a third aspect, the present invention provides a security document incorporating a security device according to the second aspect of the invention.

By providing two or more difference diffractive structures in combination with a non-diffractive structure, the optical device can generate a composite diffractive image with image components provided by respective diffractive structures, and have one or more of the component diffractive images disappear at certain viewing angles. This poses a substantial complication for would be counterfeiters seeking to replicate this optically variable effect.

The relative positioning of the different diffractive structures on or around a non-diffractive structure allows precise shielding of selected diffractive structures at particular viewing angles. The diffractive image from any shielded diffractive structure disappears from view to provide a distinctive optical effect. With accurate fabrication of the diffractive and non-diffractive structures (typically via simultaneous embossing) the shielding effect exhibits very little visual ‘cross talk’ between different diffractive images. That is, the shielding or ‘switching off’ of a diffractive image component occurs uniformly across the security device with very small changes of viewing angle.

### BRIEF DESCRIPTION OF THE DRAWINGS

Preferred embodiments of the present invention will now be described by way of example only with reference to the accompanying drawings, in which:

FIG. 1 is a schematic section view of an optical device according to the present invention;

FIG. 2A is a schematic section view of the optical device shown in FIG. 1 being viewed from a first angle, generally perpendicular to the underlying substrate surface;

FIG. 2B is a schematic section view of the optical device shown in FIG. 1 being viewed from second, more acute angles to the underlying substrate surface;

FIG. 3 is a schematic section view of an embodiment of the optical device with a non-diffractive structure supporting three different diffractive structures at different levels above the underlying substrate;

FIG. 4 is a schematic section view of the optical device of FIG. 3 indicating the diffractive elements visible when viewed from a first angle;

FIG. 5 is a schematic section view of the optical device of FIG. 3 indicating the diffractive elements visible when viewed from a second angle;

FIG. 6 is a schematic section view of another embodiment of the optical device having four different diffractive structures on a non-diffractive structure providing three different height levels above the underlying substrate;

FIG. 7 is a schematic section view of the optical device of FIG. 6 being viewed from a first angle at which only two of the different diffractive structures are visible;

FIG. 8 is a schematic section view of the optical device of FIG. 6 being viewed from a second angle at which a different pair of diffractive structures are visible;

FIG. 9 is a schematic section view of the optical device of FIG. 6 being viewed at a third angle such that only one of the diffractive structures is visible;

FIGS. 10A and 10B are schematic section views of further embodiments of the optical device operating in reflection and transmission respectively; and

FIGS. 11A to 11D show a security document in the form of a banknote incorporating a security device according to the present invention.

### DETAILED DESCRIPTION OF THE PREFERRED EMBODIMENTS

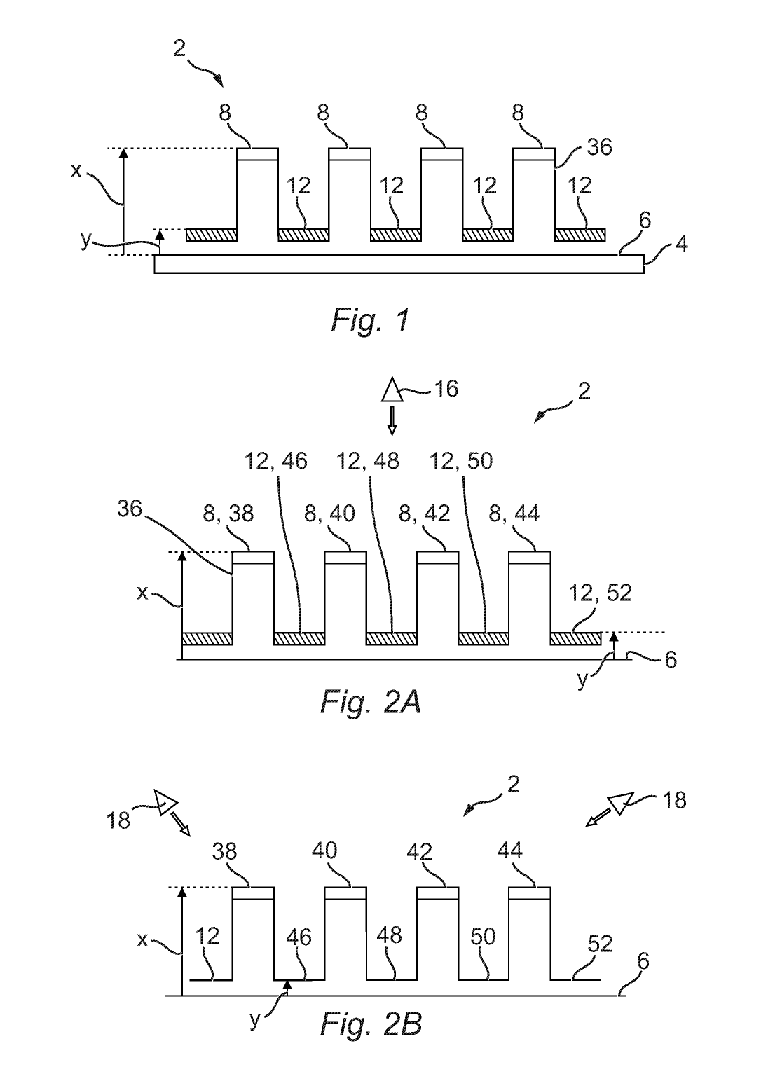

FIG. 1 is a schematic partial section view of the optical device 2 according to the present invention. A substrate 4 provides an underlying base material for a non-diffractive structure 3 on which the first and second diffractive structures (8 and 12 respectively) are formed. As previously described, the substrate 4 may be paper or other fibrous material such as cellulose, or a polymeric material such as biaxially oriented polypropylene (BOPP). The non-diffractive structure 3 is formed in a radiation curable ink 36 such that the structural features (in this case, a square wave profile) have a resolution that is too coarse to be diffractive in the visible spectrum. The first and second diffractive structures 8 and 12 are typically embossed the radiation curable ink 36 at the same time as the non-diffractive structure. This provides precise registration between the diffractive and non-diffractive structures to minimise ‘cross talk’ as the image switches.

The radiation curable ink 36 is a coating applied to the substrate 4 and embossed while still soft. The embossed coating is cured with a suitable radiation such as UV light to permanently set the non-diffractive structure 3, as well as the first and second diffractive structures 8 and 12.

The non-diffractive structure 3 supports the first diffractive structure 8 at a first height X above the planar upper surface 6 of the substrate 4, and the second diffractive structure 12 at a second, lower height Y.

Referring to FIG. 2A, the optical device 2 shown in FIG. 1 is being viewed from a first direction 16 substantially perpendicular to the upper surface 6 of the substrate 4. When viewed from the first direction 16 both the first and second diffractive structures (8 and 12 respectively) are visible. Therefore, the first and second diffractive images generated by the first and second diffractive structures are simultaneously viewed as a composite image.

The first diffractive structure 8 is made up of first diffractive elements 38, 40, 42 and 44, and the second diffractive structure is composed of the second diffractive elements 46, 48, 50 and 52. The first diffractive elements 38, 40, 42 and 44 are interleaved with the second diffractive elements 46, 48, 50 and 52.

As shown in FIG. 2B, when the optical device 2 is viewed from a second angle 18, more acute to the upper surface 6, the height difference between the first height X and the second height Y obscures second diffractive elements 46, 48, 50 and 52 from view. Only the first diffractive image generated by the first diffractive structure 8 is seen by the viewer. To obscure the second diffractive elements 46, 48, 50 and 52 at a second viewing angle 18 which is practical for the purposes of visually inspecting the optical device 2, the height difference between the first height level X and the second height level Y is at least 4 μm.

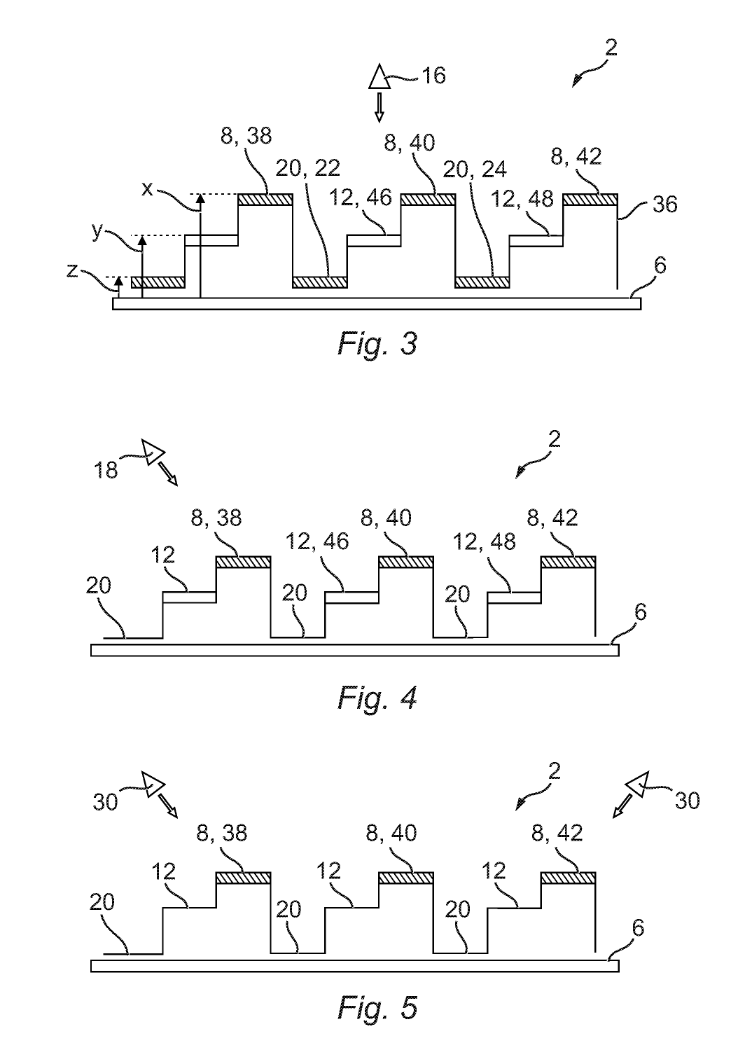

FIGS. 3, 4 and 5 show another embodiment of the optical device 2 being viewed from different angles. In this form, there is a third diffractive structure 20 formed one the non-diffractive structure 3 at a third height level Z above the upper surface 6. The third diffractive elements 22 and 24 are interlaced with the first diffractive elements 38, 40 and 42 and the second diffractive elements 46 and 48. When viewed from the first angle 16 perpendicular to the surface 6, all three diffractive structures 8, 12 and 20 are visible. Hence, all three diffractive images are visible. This is schematically represented in FIG. 11A where a optical device 2 is applied to a banknote 32. The first diffractive image 10 is the circle, the second diffractive image 14 is a euro symbol and the third diffractive image is an outer rectangle 34. When viewed from the first angle 16 as shown in FIG. 3, all three diffractive images 10, 14 and 34 are seen.

In FIG. 4, the optical device 2 is viewed from a second angle 18 that is acute to the plane of the upper surface 6. From the second angle 18 the third diffractive structure 20 is not visible because the third diffractive elements 22 and 24 seen in FIG. 3 are obscured by the taller first diffractive elements 38 and 40. However, the second diffractive structure 12 is higher than the third diffractive structure 20 and therefore the second diffractive elements 46 and 48 are not obscured. This is schematically represented in FIG. 11 B where the optical device 2 no longer shows the third diffractive image 34. Only the first and second diffractive images 10 and 14 are visible from the second angle 18.

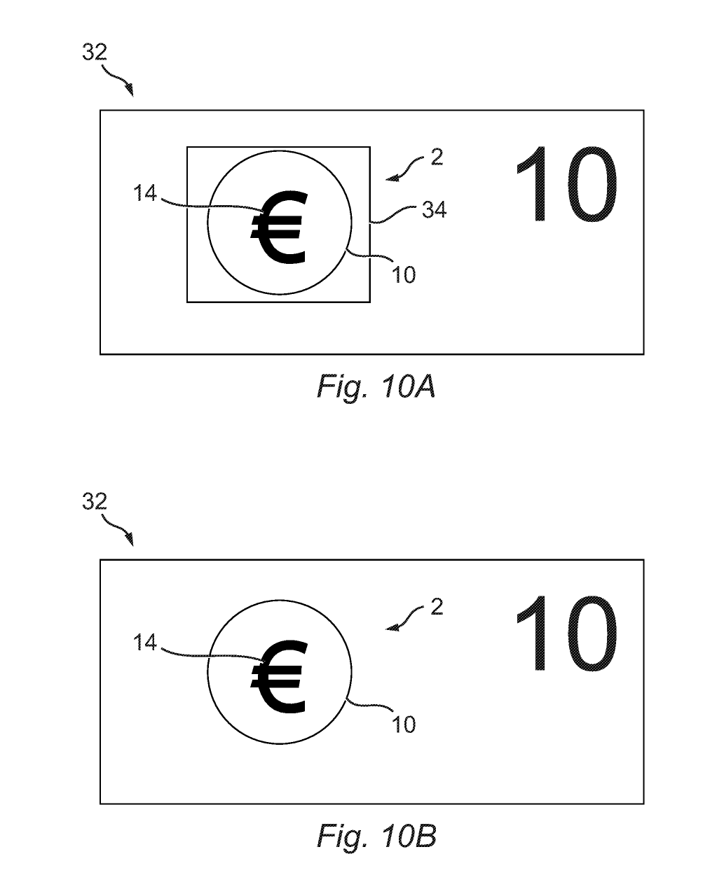

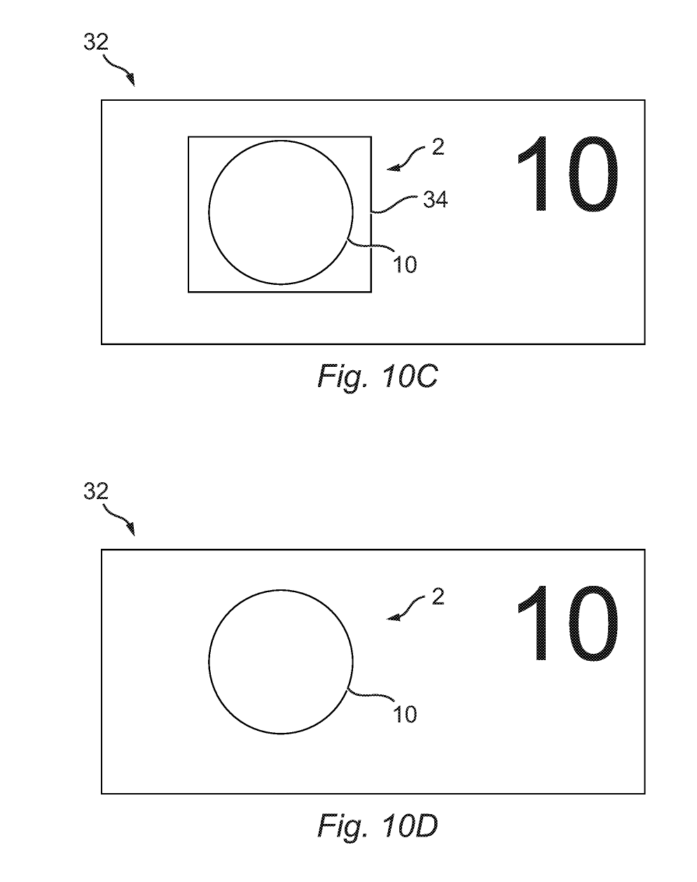

In FIG. 5, the optical device 2 is viewed from a third angle 30 which is more acute to the plane of the upper surface 6. When viewed from the third angle 30, the height difference between the first diffractive structure 8 and the second diffractive structure 12 is enough to obscure the second diffractive elements 46 and 48 seen in FIG. 4. Of course the third diffractive structure 20 remains obscured. This is schematically illustrated in FIG. 10D where the optical device 2 only shows the first diffractive image 10 when the banknote 32 is viewed from a third direction 30.

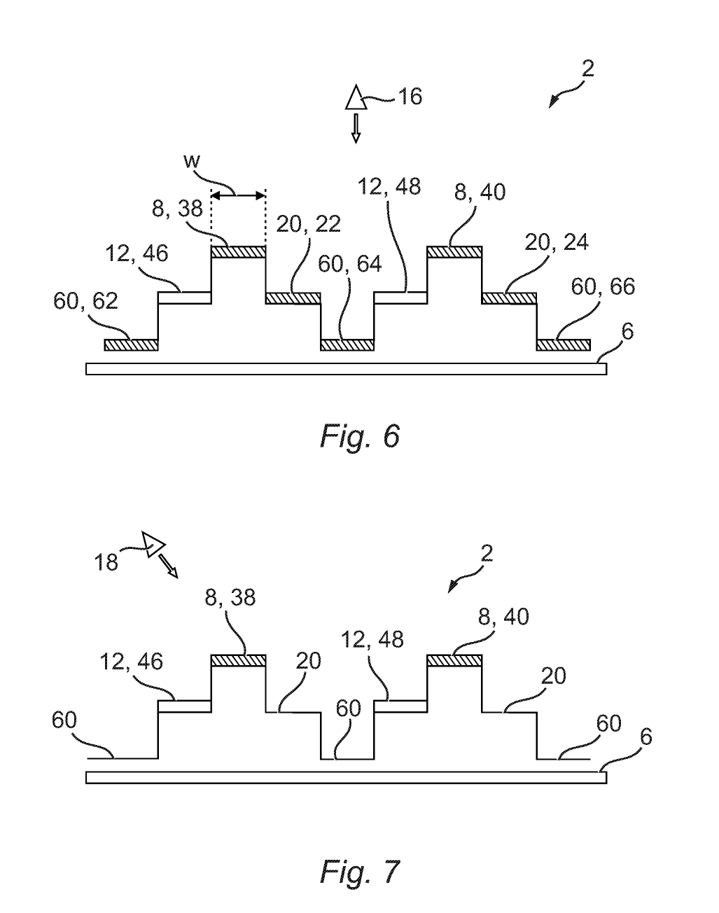

FIGS. 6, 7, 8 and 9 show another embodiment of the optical device 2 being viewed from different angles. The second diffractive structure 12 and the third diffractive structure 20 are formed on the non-diffractive structures at roughly the same height. However, the first diffractive elements 38 and 40, the second diffractive elements 46 and 48, and the third diffractive elements 22 and 24 are interleaved such that the second and third diffractive elements are on opposing sides of a taller first diffractive element. Furthermore, this embodiment of the optical device 2 has a further diffractive structure 60 with further diffractive structure elements 62, 64 and 66 formed at a further height level above the upper surface 6. This illustrates that the optical device may incorporate as many different diffractive structures at as many different height levels as is practical for the intended application of the device.

The width W of the diffractive elements can also be important when interleaved with the diffractive elements of other diffractive structures. If the viewer is intended to perceive a diffractive image as a continuous area rather than a series of parallel strips, then the widths W of the diffractive elements should be between 1 μm to 3 μm.

When viewed from the first angle 16 perpendicular to the upper surface 6 the first, second and third diffractive images (10, 14 and 34 respectively) are visible as shown in FIG. 11A. The further diffractive image (not shown) is also visible when viewed from the first angle 16.

When viewed from the second angle 18 as shown in FIG. 7, only the first diffractive structure 8 and second diffractive structure 12 are visible. The height of the first diffractive structure 8 obscures the third diffractive elements 22 and 24 and further diffractive elements 62, 64 and 66. Only the first and second diffractive images 10 and 14 are apparent to the viewer as shown in FIG. 11B. However, it will be appreciated that a combination of the first and second diffractive images (10 and 14) is only seen when the second viewing angle 18 is to the left of the orthogonal to the surface 6.

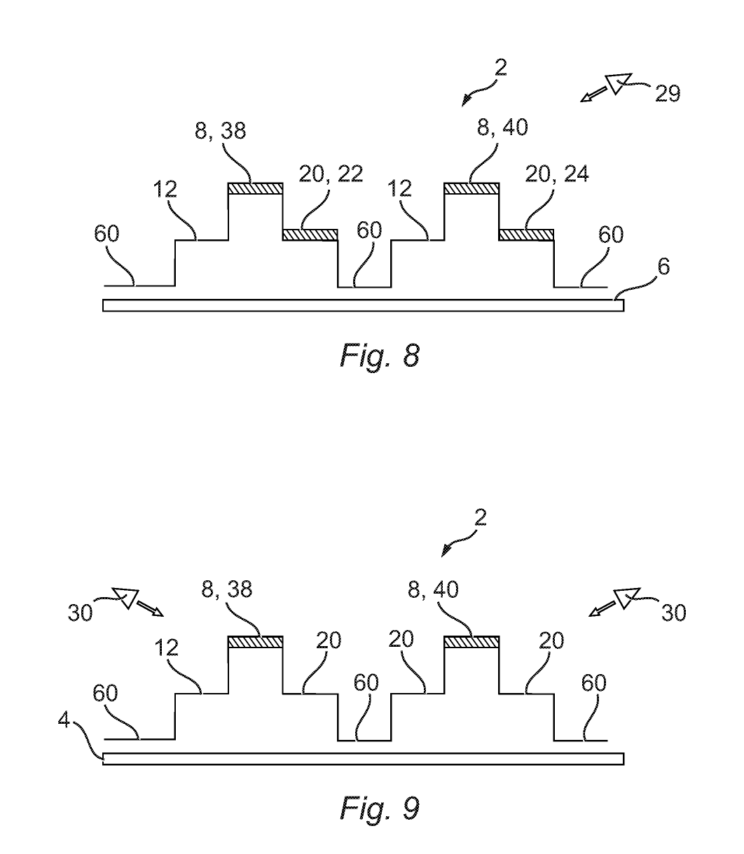

FIG. 8 shows the optical device 2 viewed form the opposing second angle 29 on the right of the orthogonal to the surface 6. From this view, the second diffractive elements 46 and 48 are obscured by the height of the first diffractive elements 38 and 40. As with FIG. 7, the further diffractive elements 62, 64 and 66 remain obscured when viewed from the opposing second angle 29. Only a combination of the first and third diffractive images (10 and 34 respectively) are perceived by the viewer as shown in FIG. 110.

FIG. 9 shows the optical device 2 viewed from a third direction 30 at an even more acute angle to the surface 6 of the substrate 4. When viewed from the third direction 30, the height of the first diffractive structure 8 is enough to obscure both the second and third diffractive structures 12 and 20 (as well as the further diffractive structure 60). In this case, it is irrelevant which side of the orthogonal the optical device 2 is viewed as only the first diffractive elements 38 and 40 are visible and generating the first diffractive image 10 as shown in FIG. 11D.

Skilled workers in this field will appreciate that a visual inspection of the optical device 2 shown in FIGS. 6 to 9 will produce a range of different image combinations as shown in FIGS. 11A to 11D. If first viewed from the third angle 30 to the left of the orthogonal to the surface 6, the viewer sees only the first diffractive image 10 as shown in FIG. 11D. Then as the viewing angle increases to the second viewing angle 18, the second diffractive image 14 is revealed as shown in FIG. 11B. As the viewing angle passes through the first angle 16, the viewer sees all three diffractive images 10, 14 and 34 (as well as any further diffractive image if present) as shown in FIG. 11A. Then as the viewing angle decreases to the opposing second angle 29 on the right of the orthogonal, the second diffractive image 14 disappears. Further decreasing the viewing angle to the third direction 30 leaves the viewer once again with only the first diffractive image 10 as shown in FIG. 11D. The visual effect created by different image combinations at different viewing angles is eye catching and easily recognisable while being exceptionally difficult to accurately replicate. Accordingly, optical devices 2, operating as security devices, described herein provide a commercially practical yet highly effective deterrent to would be counterfeiters.

FIGS. 10A and 10B show two further embodiments of the optical device 2 in which the first and second diffractive structures (8 and 12 respectively) are formed at the same height relative to the underlying substrate 4. The embodiment shown in FIG. 10A operates in reflection, while the optical device 2 of FIG. 10B operates in transmission.

Referring to FIG. 10A, the first and second diffractive structures 8 and 12 are formed side by side on the non-diffractive structure 3 as raised profile elements 5 positioned between the pairs of first and second diffractive elements. The height of the raised profile elements 5 obscures elements of the second diffractive structure 12 when viewed from the first viewing angle 18. However from this viewing angle the first diffractive structure 8 is not shielded by the raised profile elements 5, and the first diffractive image is seen by the viewer. As with the previous embodiments, the diffractive images from both the first and second diffractive structures 8 and 12 become visible as the viewing angle moves to the perpendicular. Similarly, the raised profile elements 5 will shield the first diffractive structure 8 at an opposing viewing angle past the wall to the substrate floor.

The optical device 2 shown in FIG. 10B operates in transmission. In this case, the non-diffractive structure 3 has recessed elements 7 extending into the transparent or translucent substrate 4. Light present on the underside (as depicted in FIG. 10B) of the substrate 4 transmits through the substrate material and onto the view of the corresponding viewing angle 18. The recessed elements 7 shield the lines of the second diffractive structure 12 from the light refracting through substrate 4. In this way, only the lines of the first diffractive structure 8 are illuminated in transmission when viewed from the first angle 18. However, when viewed from an angle more normal to the substrate, the diffractive images from both the first and second diffractive structures are seen. In this embodiment, the recessed elements may be filled or coated with an opaque material, or simply rely on internal reflections at the surface of the substrate material 4 to shield the first diffractive structure 8 with a second diffractive structure 12. As this embodiment operates in transmission, the diffractive structures used are preferably Diffractive Optical Elements (DOE's) or diffractive gratings.

The invention has been described herein by way of example only. Skilled workers in this field will readily recognise many variations and modifications which do not depart from the spirit and scope of the broad inventive concept.

1. An optical device for authenticating articles of value, the optical device including:
a first diffractive structure for generating a first diffractive image;
a second diffractive structure for generating a second diffractive image; and
a non-diffractive structure;
wherein, the first and/or second diffractive structures are formed on the non-diffractive structure such that when viewed from a first angle, both the first and second diffractive images are visible, and when viewed from a second angle, the first diffractive image is visible while the second diffractive structure is obscured by the non-diffractive structure.

2. An optical device according to claim 1, wherein the optical device is formed on a substrate having a first surface, wherein the first diffractive structure is at a first height relative to the first surface, and the second diffractive structure is at a second height relative to the first surface such that a difference between the first and second heights obscures the second diffractive structure when viewed from the second angle.

3. An optical device according to claim 1, wherein the non-diffractive structure has a taller profile than the first and second diffractive structures such that when viewed in reflection from the second angle, only the first diffractive image is visible.

4. An optical device according to claim 1, wherein the non-diffractive structure forms depressions between the first and second diffractive structures, and the substrate is transparent or translucent such that when viewed in transmission from the second angle only the first diffractive structure is visible.

5. An optical device according to claim 1, wherein the depressions contain opaque material.

6. An optical device according to claim 2, wherein the first and second diffractive structures each include a plurality of diffractive elements, the diffractive elements of the second diffractive structure being interlaced with the diffractive elements of the first diffractive structure.

7. An optical device according to claim 3, wherein the height difference between the first height and the second height is at least 4 μm.

8. An optical device according to claim 3, wherein the optical device further includes a third diffractive structure provided at a third height relative to the first surface for producing a third diffractive image, the third diffractive structure including a plurality of diffractive elements interlaced with the diffractive elements of the first and second diffractive structures.

9. An optical device according to claim 8, wherein the third diffractive structure is at substantially the same height as the second diffractive structure, and the diffractive elements of the second and third diffractive structures are on opposing sides of the diffractive elements of the first diffractive structure such that the first and second diffractive images are visible from the first angle, the first and third diffractive images are visible from the second angle, and the first, second and third diffractive images are visible from a third angle.

10. An optical device according to claim 8, wherein the third height is lower than the second height, and wherein the diffractive elements of the second and third diffractive structures are provided on the same side of the diffractive elements of the first diffractive structure such that the first and second diffractive images are visible from the first angle while the third diffractive image is obscured, and only the first diffractive image is visible from the second angle which is more acute than the first angle.

11. An optical device according to claim 2, wherein the non-diffractive structure provides height differences between adjacent diffractive elements of at least 1 μm.

12. An optical device according to claim 11, wherein the height differences are between 1 μm and 4 μm.

13. An optical device according to claim 8, wherein the width of the diffractive elements is between 1 μm to 3 μm.

14. An optical device according to claim 13, wherein at least one of the first, second or third diffractive images is a hologram. In a further option, at least one of the first, second or third diffractive structures is a diffractive grating.

15. A security device incorporating an optical device according to claim 1.

16. A security document incorporating a security device according to claim 15.
